(19) United States
(12) Patent Application Publication
(10) Pub. No.: US 2001/0026056 A1
(43) Pub. Date: Oct. 4, 2001

(54) Ride-on toy

(76) Inventors: Beau O'Donohue, Bexter (AU); John Bolch, Cranbourne (AU)

Correspondence Address: Abelman, Frayne & Schwab, 150 East 42nd Street, New York, NY, 10017-5612, US

(21) Appl. No.: 09/754,708

(22) Filed: Jan. 3, 2001

(30) Foreign Application Priority Data
Mar. 28, 2000 (AU) PQ 6518

(51) Int. Cl. A63C 17/14; B62B 1/10

(52) U.S. Cl. 280/87.01

(57) ABSTRACT

A ride-on toy having a body with a set for supporting a rider, the body being supported by a pair rear wheels and an undercarriage mounted to a front portion of the body, the undercarriage in turn being supported by a pair of front wheels and steering means operatively connecting the undercarriage to the body. Th steering means may be gripped by the rider for pivoting the undercarriage about the steering axis to steer the ride-on toy and facilitate motion, and the front wheels are offset from the steering axis whereby the center of gravity of the toy may be moved away from the longitudinal axis of the body by pivoting of the undercarriage. The front wheels, being offset from the steering axis, may orbit the steering axis as the undercarriage is pivoted thereabout. Furthermore, forward motion results from the pivoting of the undercarriage about the steering axis with very little shifting of body position by the rider to cause an initial “walking” or “crabbing” motion of the front wheels.

This invention relates to a ride-on toy and has particular application to a ride-on toy which is propelled by a rider shifting his or her weight on the toy to cause movement of the toy in a particular direction.

There are many types of ride-on toys including bicycles, skate boards, roller skates, toboggans, sleds and such like. However, many such ride-on toys may be unsafe for smaller children, and/or may require balancing skills. Many ride-on toys require the rider to ride in an elevated position above the ground, raising the centre of gravity and limiting safe manoeuvrability.

An object of the present invention is to provide a ride-on toy which may be propelled by a rider shifting his or her weight on the toy which is safer and/or easier for smaller or younger child to ride or at least provides an alternative to other types of ride-on toys.

With the foregoing in view, this invention resides broadly in a ride-on toy having a body with a seat portion for supporting a rider thereon in a seated attitude, the body being substantially symmetrical about a longitudinal axis and supported at its rear by a pair of spaced apart rear wheels and at its front by an undercarriage mounted to a front portion of the body for pivoting movement relative thereto about a vertical (or near vertical) steering axis, the undercarriage in turn being supported by a front wheel or a pair of spaced apart front wheels and steering means being operatively connected to the undercarriage and adapted to be gripped by the rider for pivoting the undercarriage about the steering axis or the ride-on toy and facilitate motion, and wherein the or each front wheel is mounted for rotation about a front wheel axis which is offset from the steering axis whereby the centre of gravity of the toy may be moved away from the longitudinal axis of the body by pivoting of the undercarriage by the steering means, and said front wheel axis is disposed either forward or rearward at said steering axis when said undercarriage is pivoted such that said front wheels run parallel to said rear wheels.

It will be understood that the front wheel or wheels, being offset from the steering axis, may orbit the steering axis as the undercarriage is pivoted thereabout. Furthermore, forward motion results from the pivoting of the undercarriage about the steering axis with very little shifting of body position by the rider to cause an initial “walking” or “crabbing” motion of the front wheels. It is believed that pivoting the undercarriage back and forth about the steering axis in a swinging motion causes the front wheels to follow successive opposing geometric arcs. Corresponding arcs are followed by the rear wheels, and forward movement of the ride-on-toy is effected. It is believed that if the front wheels are arranged forward of the steering axis, swinging the undercarriage, a reverse movement of the ride-on-toy may be affected.

In one form of the invention, the steering means includes a handle bar having side-by-side pedal portions (or foot rests) each being adapted to support a respective one of the rider's feet, as well as a pair of spaced apart hand grips suitable for gripping by the rider's hands. It will be appreciated that the rider can cause motion by steering the handle bar with his or her feet and hands in a somewhat forward and back, pedal-like motion. In such form, it is preferred that the handle bar be arranged in a position relative to the seat so that the rider may be seated on the seat with the hand grips disposed at a convenient location for hand gripping by the rider.

In an alternative form, the steering means includes a handle bar with a pair of hand grips as previously described, and the body includes a foot rest portion extending forward from the seat portion and including a pair of foot rests each adapted to support a respective one of the rider's feet.

Preferably, the handle bar is connected to the undercarriage in front of the steering axis by a predetermined distance, the spacing between the steering axis and the line of connection of the handle bar and the spacing between the steering axis and the front wheels governing at least in part the ease with which motion can be commenced and maintained. It is also believed that increasing the diameter of the wheels will vary the effort required to propel the ride-on toy over a particular distance. The spacing of the front wheels and their diameters also have a bearing on the ability of the rider to cause motion at the ride-on toy as well as some properties of the wheel tread material, such as hardness. Changing the composition of the wheels (such as, for example, providing types of solid or soft compound) will permit the ride-on toy to be used for travel over different terrain.

It has been found that optimum performance is achieved by having the front wheels spaced apart by a certain distance. The wheels preferably have a minimum diameter of 50 mm, but in a preferred embodiment, the ride-on toy includes a body supported by two rear wheels having a diameter of about 150 mm mounted on a rear axle about 370 mm apart from one another, the rear axle being mounted to the body, while the front of the body is supported by a steerable undercarriage assembly, connected to the body by a kingpin which provides a substantially vertical steering axis, and the undercarriage assembly includes a pair of front wheels rotatably mounted on a front axle, and spaced apart by about 115 mm from one centerline to the other, the front wheels having a width of about 35 mm and a diameter of about 120 mm. A main member extends rearward from the kingpin, the front axle being mounted thereto rearward from tho steering axis, and extends forward from the kingpin, a handlebar being connected thereto spaced forward from the kingpin. In one such form, the handlebar includes laterally extending portions immediately adjacent the main support member to provide a rest for the rider's feet, but in an alternative form, the rider's feet are supported on the body.

Preferably, the seat portion is generally triangular in shape with rounded sides and corners. In a preferred form, the base of the triangle forms the rear edge of the seat, and the other two aides form the sides of the seat, meeting at the front of the seat in a widened, rounded apex. A wide wheel base is preferably provided by arranging the rear wheels as close as is practical to the rear corners of the seat, although it is preferred that the rear wheels be located beneath the seat so that the risk of loose clothing of the rider getting caught up in the rear wheels is mimimised.

In order that this invention nay be more readily understood and put into practical effect, reference will now be made to the accompanying drawings which illustrate preferred embodiments of the invention and wherein:

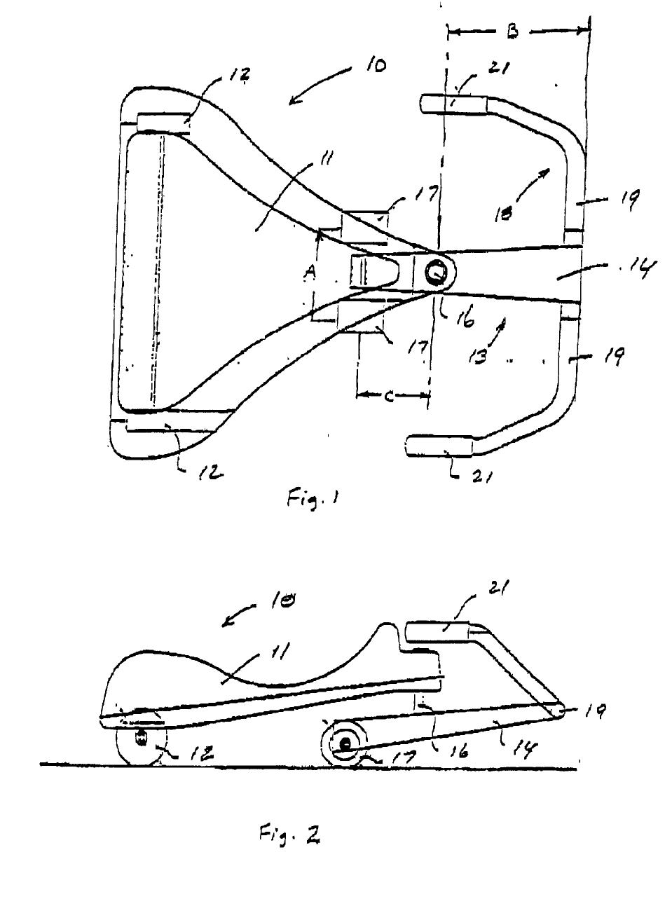

FIGS. 1 and 2 are an elevation and top plan view of a first ride-on toy according to the invention;

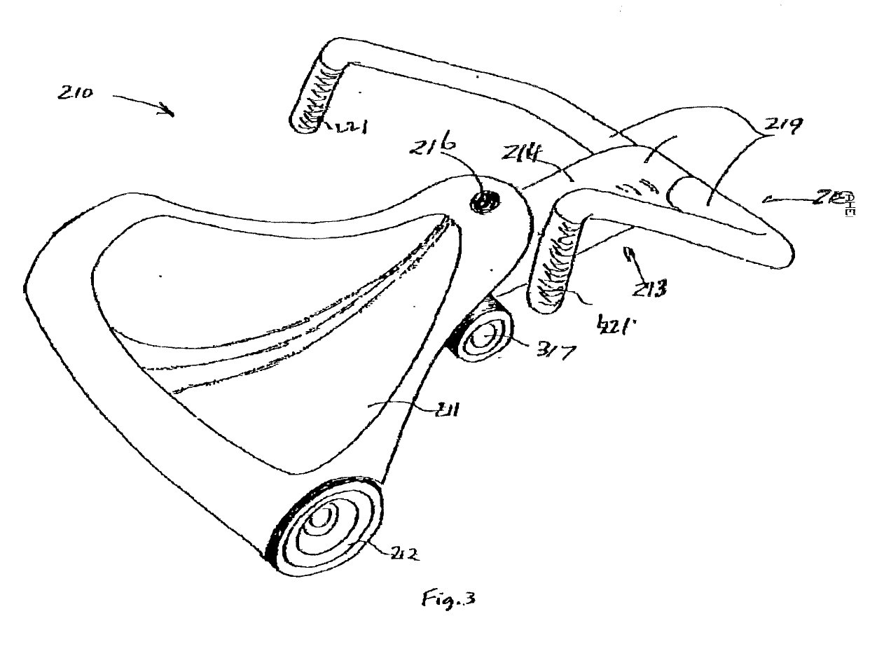

FIG. 3 is pictorial view of a second ride-on toy according to the invention;

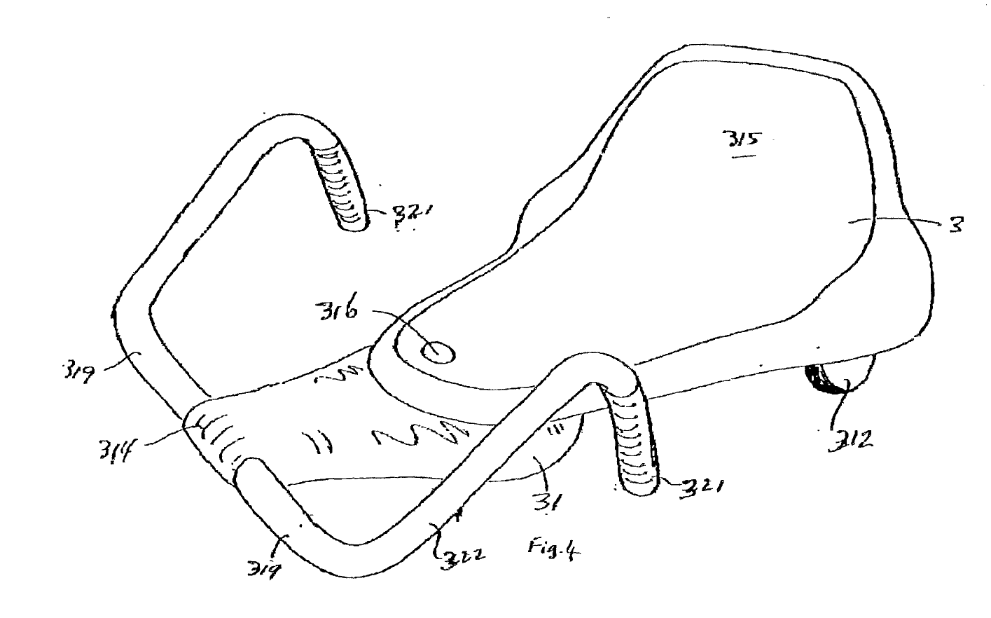

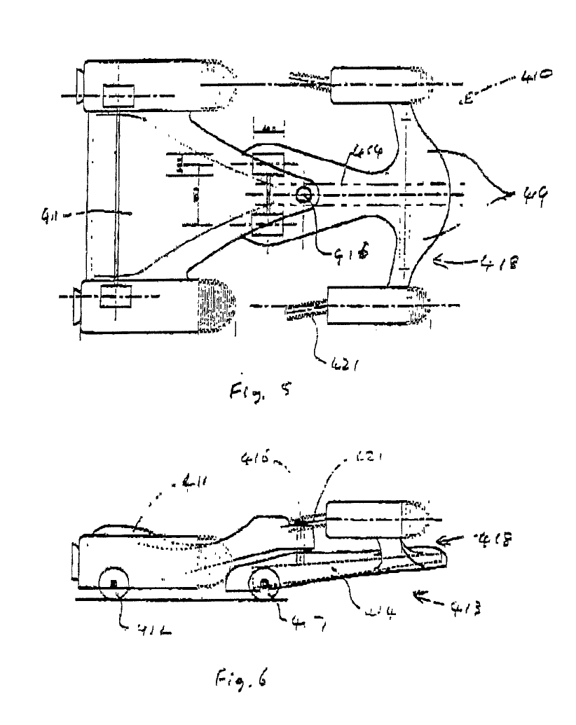

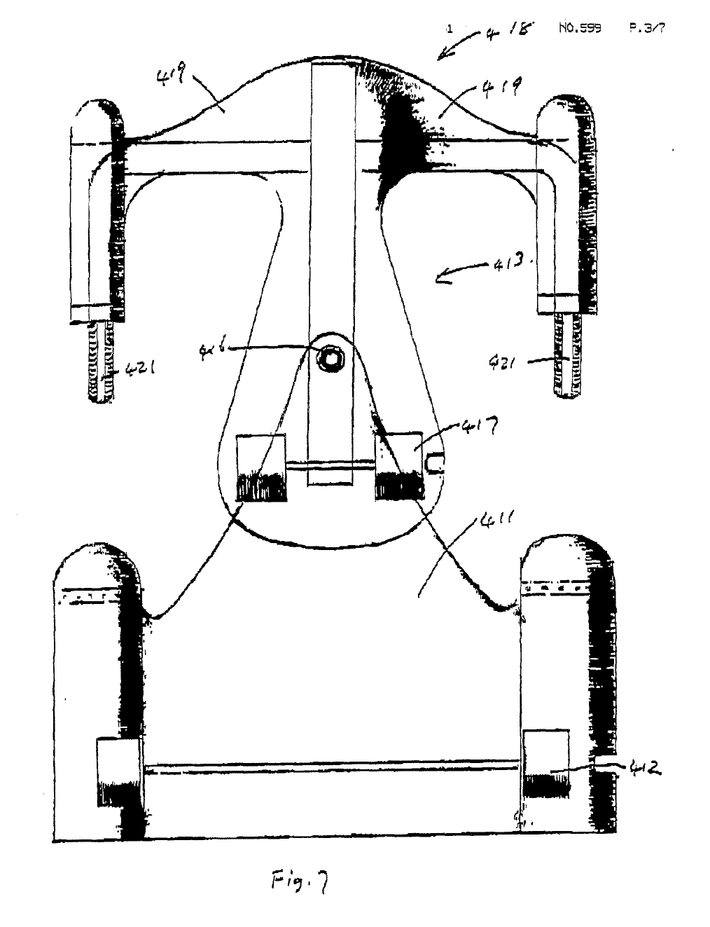

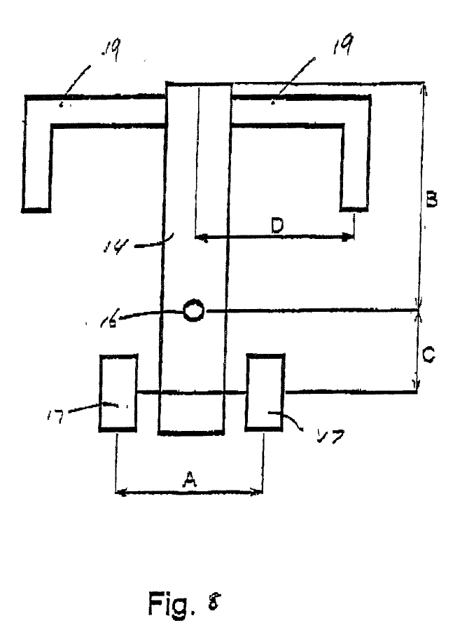

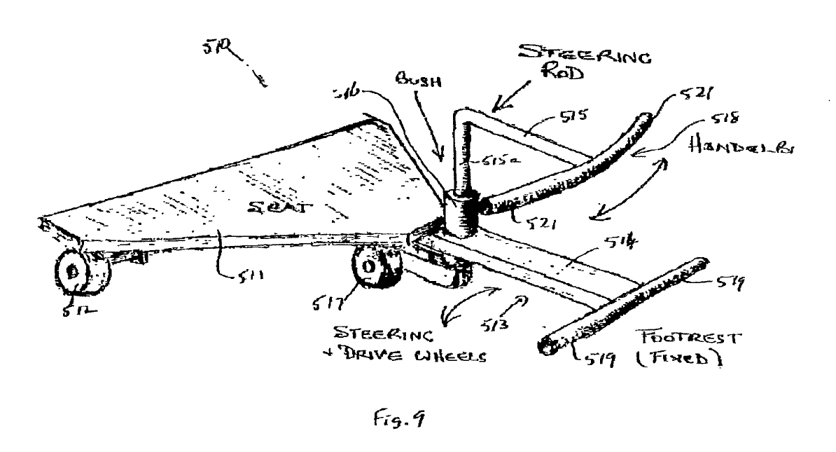

FIG. 4 is a pictorial view of a third ride-on toy according to the invention;

FIGS. 5 and 6 are a top plan view and side elevation respectively of a fourth ride-on toy according to the invention;

FIG. 7 is an enlarged top plan view of another toy which is a slight variation of the fourth ride-on toy of FIGS. 5 and 6;

FIG. 9 is a diagrammatic top plan view of an undercarriage for the ride-on toys of FIGS. 1 to 7;

FIG. 9 is a pictorial view of a fifth ride-on toy with fixed foot rests according to the invention;

FIG. 10 is a top plan view of the fifth ride-on toy of FIG. 9;

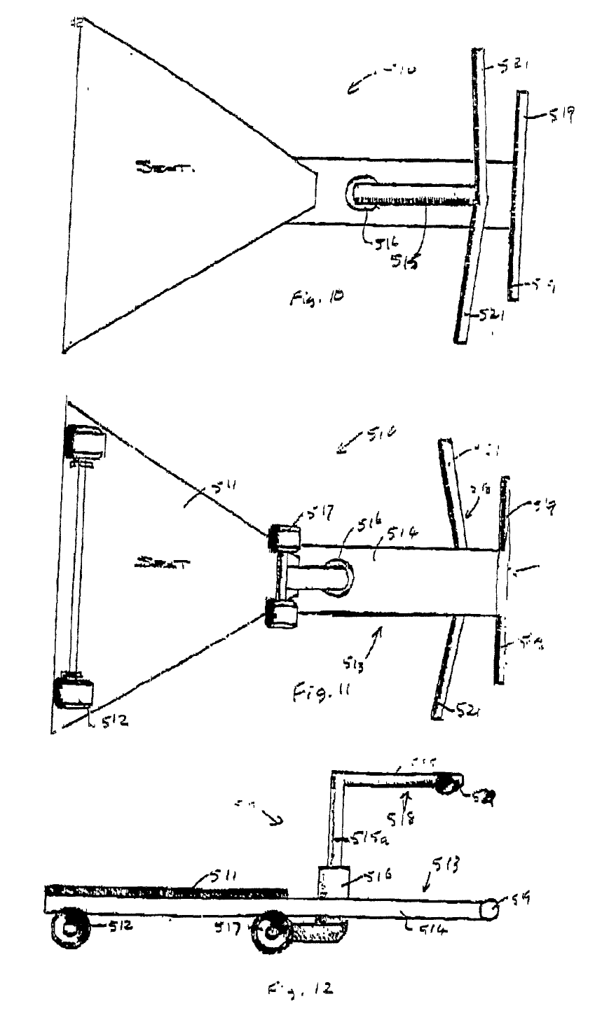

FIG. 11 is a bottom plan view of the fifth ride-on toy of FIGS. 9 ad 10;

FIG. 12 is a side elevation of the fifth ride-on toy of FIGS. 9 to 11, and

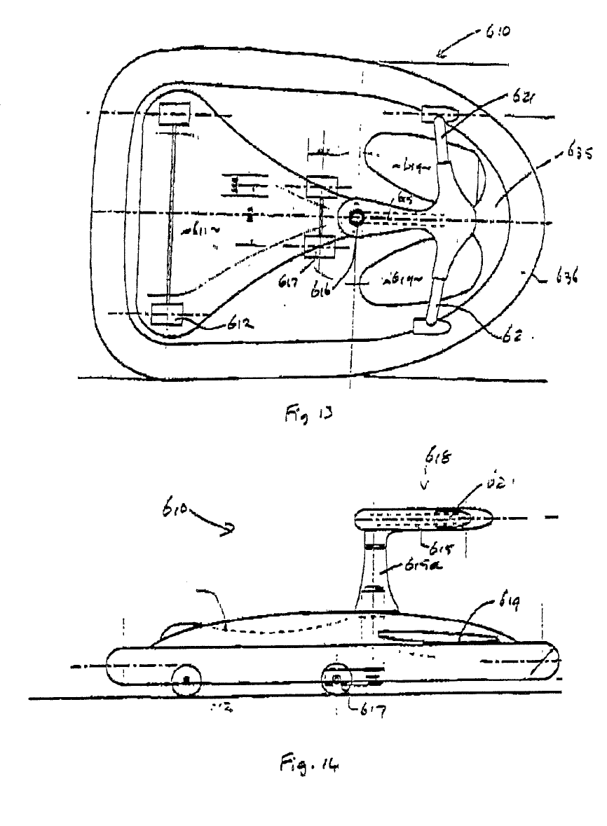

FIGS. 13 and 14 are a top plan view and a side elevation respectively of a sixth ride-on toy with fixed foot rests in accordance with the invention.

The first ride-on toy 10 illustrated in FIGS. 1 and 2 includes a body 11 supported by two rear wheels 12 having a diameter of 150 mm and being spaced apart by about 370 mm and mounted on an axle extending through the lowermost rear portion of the body. The body is substantially triangular in plan view with the rear end being the widest part and the front forming the apex at the triangle. The front of the body is supported by an undercarriage assembly 13 having a main support member 14 which is pivotally connected to the body by a kingpin 16 and in turn is supported by a pair of front wheels 17 spaced apart by a centerline. The front wheels have a width of 38 mm and a diameter of 120 mm in this case.

It will be seen that the front wheels are spaced behind the kingpin by a distance “C” and that the main member extends forward of the kingpin while a handlebar is connected to the main member at or near its front end, being spaced forward from the kingpin by a distance “B”. The handlebar is somewhat in the form of a bicycle handlebar extending sidewards in each direction from the main member and then rearwards to terminate in two hand grips 21, one at each end of the handlebar. The laterally extending portions 19 of the handlebar immediately adjacent the main support member provide a rest for the rider's feet and it will be appreciated that alternating forward and backwards movement of the feet in a pedal-like motion are effective to pivot the undercarriage back and forth about the kingpin to steer the toy and facilitate motion. In this respect, the rider can cause the undercarriage to pivot about the kingpin by moving his or her feet and hands which results in the front wheels orbiting about the axis of the kingpin so that by shifting his or her weight to one aide or the other, one wheel is forced to grip more than the other to create an initial “walking” or “crabbing” motion which then settled into general forward motion with only a small amount of pivoting movement required.

The front wheels are formed from cast polyurethane and have a very high grip at a hardness of about 75 Shore A-Scale and the rear wheels are formed from injection moulded polyurethane with a low friction surface at a hardness of about 94 Shore A-scale. The wheel spacings, sizes and hardness of the second toy 210 of FIG. 3, the third toy 310 of FIG. 4 and the fourth ride-on toy of FIGS. 5 to 7 are the same as those in the toys of FIGS. 1 and 2 wherein like parts are given the same reference numerals as in FIGS. 1 and 2 except preceded by a “2”, “3”, and “4” respectively. The second and third ride-on toys are similar to the first ride-on toy except that the hand grips 221 and 321 are oriented downward whereas the hand grips 21 of the first ride-on toy are somewhat horizontal. Advantageously, this allows a rider to apply more leverage than in the case of rearwardly directed longitudinal hand grips. The fourth ride-on toy has a rounded moulded body and hand grips disposed obliquely and slightly outward (parallel in the case of FIG. 7).

Referring now to FIG. 8, it has been found that the various spacings “A”, “B”, “C”, and “D” can be varied to improve toy performance and also to suit different ages and strengths of riders. It is believed that by using a larger rear wheel, the forward center of gravity is increased and that narrower rear wheels should improve the operation of the toy, particularly if the rear wheels have a lower coefficient of friction. Also, increasing the distance “B” and the distance “D” as well as the distances “A” will afford the rider greater mobility with less effort.

In the fifth and sixth ride-on toys 510 And 610 shown in FIGS. 9 to 14, corresponding parts to the other ride-on toys are preceded with a “5” and “6” respectively. The foot rests 19 of FIGS. 1 and 2 are not disposed on the undercarriage assembly, but as a fixed forward extension 513 including a fixed main support member 514 extending forward of the seat, and two foot rest bars 519, as can be seen in particular in FIGS. 10 and 11. The relative distances “A”, “B”, “C” and “D” described in relation to FIG. 8 correspond in like manner to the corresponding parts of the fifth and sixth ride-on toys.

In the case of the fifth ride-on toy, a relatively simple form is adopted to show the working arrangements of the basic parts. Although the seat is shown as a simple flat triangular panel with corners cut off, and the main support member 514 is shown as a simple rectilinear member, it will be appreciated that more aesthetic designs may be applied.

In the came of the sixth ride-on toy shown in FIGS. 13 and 14, the body 611 has been extended beyond the simple seat arrangement so that the seat, main support member, and foot rests are incorporated into a rounded curvaceous and aesthetically pleasing form. The foot rests 619 are provided in the form of sole-shaped platforms or recesses in a body moulding 635 which has a peripheral bumper 636 surrounding the seat, foot rests and associated panelling. A handlebar assembly 618 includes two hand gripe 621 at or near its ends and a vertical portion 615a extending upwardly from the kingpin 616. The foot rests are disposed forward of, and to the sides of, the kingpin 616 at ergonomically comfortable spacings from the seat and from one another.

The first to fourth ride-on toys may be propelled, in use, by swaying on the seat from side to side as the handlebars are pushed from side to side by the feet and hands the ride-on toy may be propelled forward on a flat surface and even up a slight incline at a velocity, with practice, close to walking speed. Because of the seated position of the rider close to the ground, the risk of toppling off the toy or tipping the toy over is very low. The rider may practice balancing skills, for example by leaning into corners in a similar fashion to riding a bicycle or skateboard thus training him or her for riding more sophisticated toys such as skateboards.

The fifth and sixth ride-on toys are propelled in use in a similar fashion to the fourth ride-on toys, with the exception that the feet of the rider are not involved in steering the front wheels. In every other respect, the operation is the same, especially the shifting of the weight of the rider and the crabbing motion to initiate movement.

Although the invention has been described with reference to several specific examples, it will be realized by persons skilled in the art that the invention may be embodied in many other forms within the broad scope and ambit of this invention as claimed in the following claims.

I claim:

1. A ride-on toy having a body with a seat portion for supporting a rider thereon in a seated attitude, the body being substantially symmetrical about a longitudinal axis and supported at its rear by a pair of spaced apart rear wheels and at its front by an undercarriage mounted to a front portion of the body for pivoting movement relative thereto about a vertical (or near vertical) steering axis, the undercarriage in turn being supported by a front wheel or d pair of spaced apart front wheels and steering means being operatively connected to the undercarriage and adapted to be gripped by the rider for pivoting the undercarriage about the steering axis to steer the ride-on toy and facilitate motion, and wherein the or each front wheel is mounted for rotation about a front wheel axis which is offset from tho steering axis whereby the centre of gravity at the toy may be moved away from the longitudinal axis of the body by pivoting of the undercarriage by the steering means, and said front wheel axis is disposed either forward or rearward of said steering axis when said undercarriage is pivoted such that said front wheels run parallel to said rear wheels.

2. A ride-on toy according to claim 1, wherein the steering means includes a handle bar having side-by-side pedal portions (or foot rests) each being adapted to support a respective one of the rider's feet, and a pair of spaced apart hand grips suitable for gripping by the rider's hands.

3. A ride-on toy according to claim 1, wherein the steering means includes a handle bar with a pair of hand grips disposed at a convenient location for hand gripping by the rider, and the body includes a foot rest portion extending forward from the seat portion and including a pair of foot rests each adapted to support a respective one of the rider's feet.

4. A ride-on toy according to claim 3, wherein the handle bar is connected to the undercarriage offset from the steering axis by a predetermined distance, whereby the spacing between the steering axis and the line of connection of the handle bar and the spacing between the steering axis and the front wheels governing at least in part the ease with which motion can be commenced and maintained.

5. A ride-on toy according to claim 4, wherein the body is supported by two rear wheels having a diameter of about 150 mm mounted on a rear axle about 370 mm apart from one another, the rear axle being mounted to the body, while the front of the body is supported by a steerable undercarriage assembly, connected to the body by a kingpin which provides a substantially vertical steering axis, and the undercarriage assembly includes a pair of front wheels rotatably mounted on a front axle, and spaced apart by about 115 mm from one centerline to the other, the front wheels having a width of about 35 mm and a diameter of about 120 mm, a main member extending laterally from the kingpin, the front axle being mounted thereto laterally from the steering axis, and extends laterally from the kingpin on the other side thereof from the main member, and a handlebar being connected thereto spaced forward from the kingpin. In one such form, the handlebar includes laterally extending portions immediately adjacent the main support member to provide a rest for the rider's feet, but in an alternative form, the rider's feet are supported on the body.

6. A ride-on toy according to claim 5, wherein the seat portion is generally triangular in shape with rounded sides and corners, the base of the triangle forming the rear edge of the seat, and the other two sides forming the side of the seat, meeting at the front of the seat in a widened, rounded apex, whereby a wide wheel base is provided by arranging the rear wheels as close as is practical to the rear corners of, but beneath the seat.
